(19) United States
(12) Patent Application Publication
(10) Pub. No.: US 2025/0328313 A1
(43) Pub. Date: Oct. 23, 2025

(54) MANTISSA ALIGNMENT WITH ROUNDING

(71) Applicant: Taiwan Semiconductor Manufacturing Company, Ltd., Hsinchu (TW)

(72) Inventors: Xiaochen PENG, Hsinchu (TW); Brian Crafton, Hsinchu (TW); Murat Kerem Akarvardar, Hsinchu (TW)

(21) Appl. No.: 18/640,120

(22) Filed: Apr. 19, 2024

(51) Int. Cl. G06F 7/499; G06F 7/485; G06F 7/487

(52) U.S. Cl. CPC G06F 7/49947; G06F 7/485; G06F 7/4876; G06F 7/49915

(57) ABSTRACT

In some embodiments, computing a sum of floating-point numbers, such as in multiply-accumulate operations, includes aligning the mantissas of the floating point number by adjusting at least a subset of the mantissas so that the exponents of the floating-point numbers are the same. After the alignment, the most significant portion of each mantissa is rounded depending on the remainder of the mantissa, for example the most significant bit of the remainder. The mantissas are then truncated to the rounded most significant portions. The truncated mantissas are then summed. The mantissas being aligned can be products of mantissas of respective inputs and weights. The sum of the rounded portions in such cases are a result of multiply-accumulate operations, with a reduced bit width.

### BACKGROUND

This disclosure relates generally to floating-point arithmetic operations in computing devices, for example, in in-memory computing, or compute-in-memory (“CIM”) devices and application-specific integrated circuits (“ASICs”), and further relates to methods and devices used data processing, such as multiply-accumulate (“MAC”) operations. Compute-in-memory or in-memory computing systems store information in the main random-access memory (RAM) of computers and perform calculations at memory cell level, rather than moving large quantities of data between the main RAM and data store for each computation step. Because stored data is accessed much more quickly when it is stored in RAM, compute-in-memory allows data to be analyzed in real time. ASICs, include digital ASICs, are designed to optimize data processing for specific computational needs. The improved computational performance enables faster reporting and decision-making in business and machine learning applications. Efforts are ongoing to improve the performance of such computational memory systems, and more specifically floating-point arithmetic operations in such systems.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion. In addition, the drawings are illustrative as examples of embodiments of the invention and are not intended to be limiting.

FIG. 1A schematically illustrates rounding a most significant portion, of M bits, of an L-bit mantissa in a storage device, such as a register, before truncating the remainder (L-M bits), resulting in an M-bit truncated mantissa, in accordance with some embodiments. The L-bit mantissa in some examples is a product mantissa, i.e., a product of mantissas of pair of floating-point numbers. In some embodiments, the product mantissa is a post-aligned mantissa, i.e., a product mantissa belonging to a set of product mantissas, at least a subset of which is multiplied by respective integer powers of the base (2 for binary) so that all products of floating-point number pairs have the same exponents.

FIG. 1B schematically illustrates truncating an L-bit mantissa in a storage device, such as a register, to a most significant portion, of N bits, without rounding, resulting in an N-bit truncated mantissa. In at least some floating-point operations, such as MAC, with proper choice of truncated bit-width M<N, the same level of computational accuracy is achieved.

FIG. 2 outlines a MAC operation, including rounding and truncating product mantissas, in accordance with some embodiments.

FIG. 3 outlines in more detail the mantissa part of the MAC operation outlined in FIG. 2 and schematically illustrates the system for implementing the operation, in accordance with some embodiments.

FIG. 4 outlines in more detail the mantissa part of the MAC operation outlined in FIG. 3 and schematically illustrates the system for implementing the operation, in accordance with some embodiments.

FIGS. 5A-D schematically illustrate details of a MAC operation and system for implementing the operation, in accordance with some embodiments.

FIG. 6 provide an example of computational accuracy achieved by a process using MAC operations including rounding in accordance with some embodiments, as compared to a process without rounding.

FIG. 7 outlines a general computational process in accordance with some embodiments.

FIG. 8 is a block diagram illustrating a computer system that is programmed to implement computational operations in accordance with some embodiments.

FIG. 9 schematically illustrates a part of a MAC operation and system for implementing the operation as alternative to those illustrated in FIGS. 5C and 5D, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

This disclosure relates generally to floating-point arithmetic operations in computing devices, for example, in in-memory computing, or compute-in-memory (“CIM”) devices and application-specific integrated circuits (“ASICs”), and further relates to methods and devices used data processing, such as multiply-accumulate (“MAC”) operations. Computer artificial intelligence (“AI”) uses deep learning techniques, where a computing system may be organized as a neural network. A neural network refers to a plurality of interconnected processing nodes that enable the analysis of data, for example. Neural networks compute “weights” to perform computation on new input data. Neural networks use multiple layers of computational nodes, where deeper layers perform computations based on results of computations performed by higher layers.

CIM circuits perform operations locally within a memory without having to send data to a host processor. This may reduce the amount of data transferred between memory and the host processor, thus enabling higher throughput and performance. The reduction in data movement also reduces energy consumption of overall data movement within the computing device.

Alternatively, MAC operations can be implemented in other types of system, such as a computer system programmed to carry out MAC operations.

In a MAC operation, a set of input numbers are each multiplied by a respective one of a set of weight values (or weights), which may be stored in a memory array. The product is then accumulated, i.e., added together to form an output number. In certain applications, such as neural networks used in machine learning in AI, the output resulted from MAC operations can be used as a new input values in the next iteration of MAC operations in a succeeding layer of the neural network. An example of the mathematical description of the MAC operation is shown below.

$${O}_{J} = {\sum }_{I = 1}^{h - 1} ( {A}_{I} \times {W}_{IJ} ) , \qquad ( 1 )$$

where A_{I} is the I-th input, W_{IJ} is the weight corresponding to the I-th input and J-th weight column. O_{J} is the MAC output of the J-th weight column, and h is the accumulated number.

In a floating-point (“FP”) MAC operation, a FP number can be expressed as a sign, a mantissa, or significand, and an exponent, which is an integer power to which the base is raised. A product of two FP numbers, or factors, can be represented by the product of the mantissas (“product mantissa”) and sum of exponents of the factors. The sign of the product can be determined according to whether the signs of the factors are the same. In a binary floating-point (“FP”) MAC operation, which can be implemented in digital devices such as digital computers and/or digital CIM circuits, each FP factor can be stored as a sign (e.g., a single sign bit), a mantissa of a bit-width (number of bits), and an integer power to which the base (i.e., 2) is raised. In some representation schemes, the integer portion (i.e., 1_{b}) of a normalized binary FP number is a hidden bit, not stored because it is assumed. In some representation schemes, a binary FP number is normalized, or adjusted such that the mantissa is greater than or equal to 1_{b} but less than 10_{b}. That is, the integer portion of a normalized binary FP number is 1_{b}. A product of two FP numbers, or factors, can be represented by the product mantissa, a sum of the exponent of the factors, and a sign, which can be determined, for example, by comparing the signs of the factors.

To implement accumulation part of a MAC operation, in some procedures, the product mantissas are first aligned. That is, if necessary, at least some of the product mantissas are modified by appropriate orders of magnitude so that the exponents of the product mantissas are all the same. For example, product mantissas can be aligned to have all exponents be the maximum exponent of pre-alignment product mantissas. Aligned mantissas can then be added together (algebraic sum) to form the mantissa of the MAC output, with the maximum exponent of pre-alignment product mantissas.

To improve performance of computational devices, such as deep neural networks (“DNNs”) involving multiple layers executing iterations of MAC operations, it is desirable to minimize the bit-width of mantissas, such as post-alignment mantissas. A reduction in the bit-width can lead to improved power-performance-area (PPA) balance for operations involving the mantissas, such as accumulation. However, simply truncating mantissas may lead to unacceptable degradation in computational inaccuracy.

According to some embodiments disclosed in the present disclosure, a method of computing includes: for a set of binary numbers, each having a respective mantissa (of length L bits), sign associated with the mantissa, and exponent, providing in a memory device, such as a register, the mantissas; modifying at least one of the mantissas provided in the memory device to obtain a set of respective modified (e.g., aligned) mantissas so that the exponents of the binary numbers are the same, each of the modified mantissas having a most significant portion of a predetermined number (M) of bits, and a remainder portion (L-M), and storing the modified mantissas in a memory device; rounding the most significant portion of each of the stored modified mantissas at least in part according to the respective remainder portion to generate a truncated mantissa; and storing the truncated mantissas in a memory device without storing the remainder portions. For example, the rounding can include rounding the most significant portion of each of the stored modified mantissas according to the most significant bit of the remainder, i.e., the (M+1)-th most significant bit. For example, the most significant portion is rounded up (i.e., incremented by 1) if the (M+1)-th most significant bit is a 1; the most significant portion remains unchanged if the (M+1)-th most significant bit is a 0. In some embodiments, rounding is accomplished by adding the value of the (M+1)-th most significant bit to the most significant portion.

In some examples, an algebraic sum of the (M+1)-th most significant bits of the mantissas, each of the (M+1)-th most significant bits attributed the respective sign of the FP number the bit is a part of, is obtained and added to the algebraic sum of the most significant portions of the mantissas without rounding.

In some embodiments, a computing device includes: one or more first digital circuits configured to receive a set of digital input signals indicative of respective input digital numbers of a base (e.g., 2), each of the one or more first digital circuits being configured to receive a respective one or more of the digital input signals and modify each of the one or more of the digital input signals to generate a respective output signal indicative of an output digital number that is the input digital number times an integer power of the base (e.g., ×2ⁿ, where n is an integer); one or more second digital circuits configured to round a most significant portion of a predetermined bits of each output digital number from the one or more first digital circuits depending at least in part on a remainder portion of the output digital number to generate an output signal indicative of the rounded most significant portion without the respective remainder portion; and an accumulator configured to combine (e.g., compute an algebraic sum of) the output signals of the one or more second digital circuits.

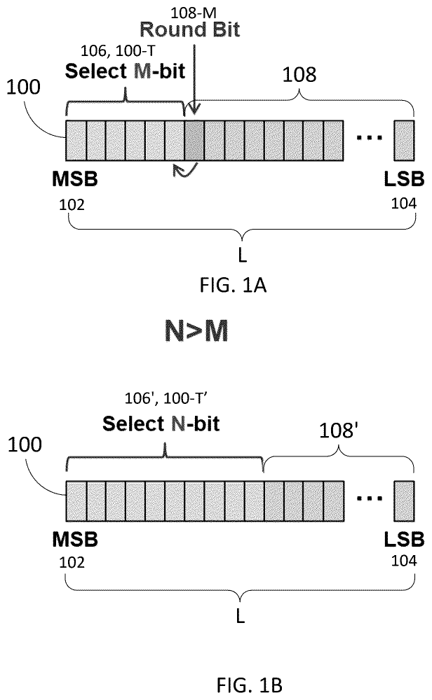

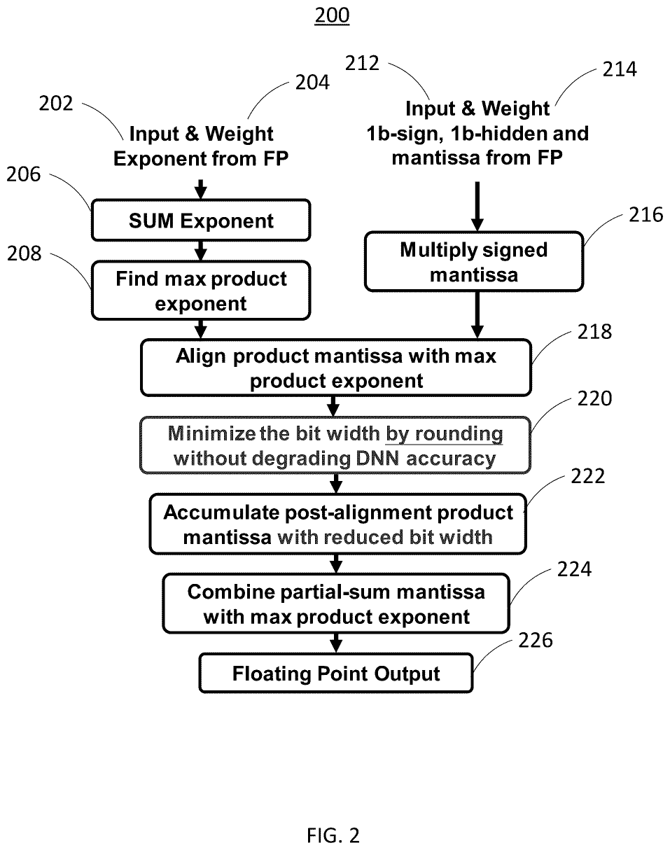

As an example, in some embodiments, illustrated in FIGS. 1A and 1B, a binary number 100 of length L bits, which in some applications can be the mantissa of a binary number (e.g., an aligned product mantissa), has a most significant bit (“MSB”) 102 and a least significant bit (“LSB”) 104, and is stored in a memory device, such as a register. In the example in FIG. 1A, the most significant portion 106, consisting of the most significant M bits is rounded basted on the remainder portion 108, consisting of the remainder L-M bits. In a more specific example, the round bit 108-M, which is the most significant bit of the remainder portion 108 is used as a basis for the rounding. In one example, if the round bit 108-M is 1, the most significant portion 106 is rounded up, i.e., incremented by 1; if the round bit 108-M is 0, the most significant portion 106 remains unchanged. In subsequent operations, such as accumulation in a MAC operation, only the rounded most significant portion 106, which forms a truncated binary number 100-T, is used. The remainder portion 108, including the round bit 108-M, is not used.

The example of truncation with rounding in FIG. 1A is contrasted with simple truncation without rounding, which is illustrated in FIG. 1B, in which the most significant portion 106′, consisting of the most significant N (N>M) bits, is selected without regarding to the remainder portion 108′, consisting of the remainder L-N bits. In subsequent operations, such as accumulation in a MAC operation, only the most significant portion 106′, which forms a truncated binary number 100-T′, is used. The remainder portion 108′ is not used. In certain computational operations, such as certain neural network operations involving MAC operations, truncation with rounding is capable of achieves a similar computational accuracy as truncation without rounding using a smaller bit-width (M<N). Viewed another way, truncation with rounding is capable of achieves a higher degree of computational accuracy as truncation without rounding using a the same bit-width (M=N).

It is noted that the blocks illustrating the bits of binary numbers also represent devices, such as memory cells in a register, storing the binary numbers.

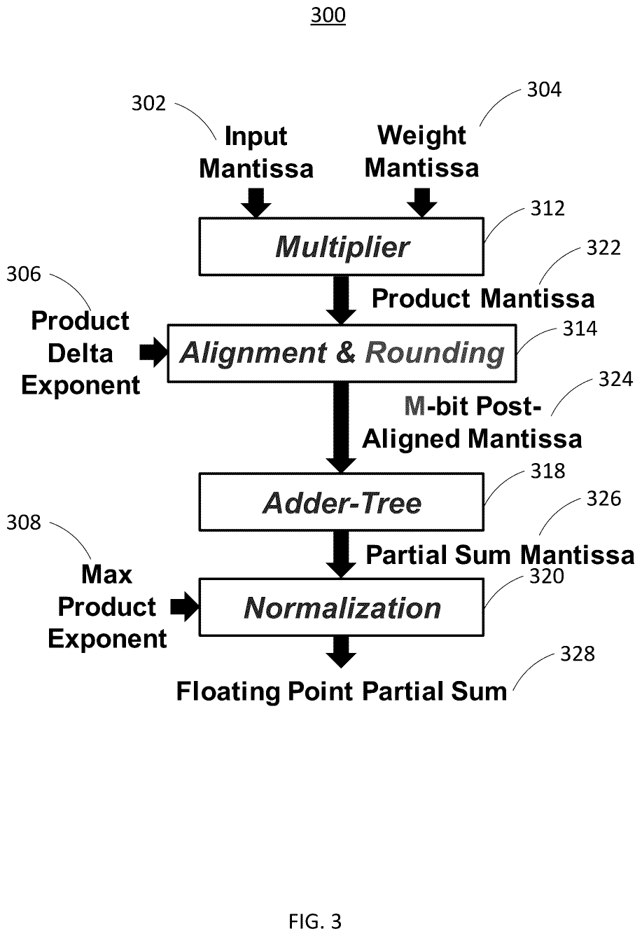

In some embodiments, a MAC operation 200 using truncation with rounding is carried out as outlined in FIG. 2. To multiply two FP numbers, such as one of a set of input numbers and one of a set of weight values, the exponents (“product exponents”) 202, 204 of the FP numbers are added together 206 to obtain the exponent of the product. The maximum product exponent among all product exponents produced by the multiply operation between the two sets of FP numbers is then identified, for example, by comparing each product exponent with all other product exponents, using, for example, one or more comparators. Further, the mantissas 212, 214 of the FP numbers are multiplied by each other 216, taking into account the signs and hidden bits of the mantissas, to obtain the product mantissa. The multiplication can be carried out in a multiply circuit, which can be any circuit capable of multiplying two digital numbers. For example, U.S. patent application Ser. No. 17/558,105, published as U.S. Patent Application Publication No. 2022/0269483 A1 and U.S. patent application Ser. No. 17/387,598, published as U.S. Patent Application Publication No. 2022/0244916 A1, both of which are commonly assigned with the present application and incorporated herein by reference, disclose multiply circuits used in CIM devices. In some embodiments, a multiply circuit includes a memory array that is configured to store one set of the FP numbers, such as weight values; the multiply circuit further includes a logic circuit coupled to the memory array and configured to receive the other set of FP numbers, such as the input values, and to output signals, each based on a respective stored number and input number.

The product mantissas are then aligned with each other 218 using the maximum product exponent. In some embodiments, the difference, ΔE, between the exponent of each product mantissa and the maximum exponent is calculated, for example, using an adder, and the mantissa is multiplied by the base raised to the (ΔE)-th power, so that the product mantissas have the same, maximum exponent after the modifications. The multiplication of the mantissa by the base raised to the (ΔE)-th power can be implemented by shifting, for example using a shift register, the mantissa to the right by ΔE bits. That is, the mantissa is divided by 2^{ΔE}, and the exponent is effectively increased by ΔE and become the maximum exponent. The product mantissas are then post-alignment product mantissas.

Next, each product mantissa is truncated 220 to a shortened bit-width with rounding has described above. The truncated product post-alignment mantissas are then accumulated 222, for example, using an algebraic summing device, such as an adder, to obtain a partial-sum product mantissa. The partial-sum product mantissa and the maximum exponent are combined 224 to form a partial sum FP number, which is output 226 to be used in further computational processes, such as the MAC operation in a next deeper layer of a neural network.

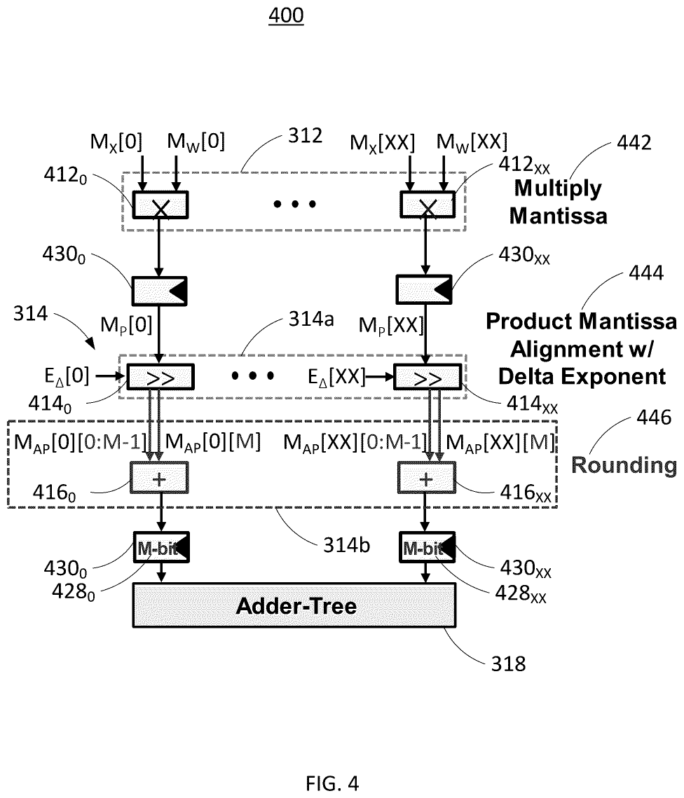

A system 300 for carrying out the mantissa part of the MAC operation outlined above is schematically shown in FIG. 3. A multiplier 312, such as a multiply circuit described above is configured to receive an input mantissa 302 and weight mantissa 304 and to generate a product mantissa 322. An alignment and rounding circuit 314, which is described in more detail below, is configured to receive the product mantissa 322 and product delta exponent 306, i.e., ΔE described above, and align the product mantissa 322 based on ΔE, as described above. The alignment and rounding circuit 314 is further configured to truncate the post-alignment mantissa with rounding, as described above and output a rounded and truncated post-alignment mantissa 324. A summing device, such as an adder tree 318 is configured to receive the truncated post-alignment mantissa 324 and accumulate all received truncated post-alignment mantissas generate a partial sum mantissa 326. A normalization circuit 320, which in some examples includes a shift register is configured to receive the partial sum mantissa 326 and store it together with the maximum product exponent 308 to form a FP number. The normalization circuit 320 further shifts the partial sum mantissa 326 and correspondingly increment or decrement the maximum exponent 308 so that the stored FP number is normalized. The normalized FP number is output by the normalization circuit 320 as a floating point partial sum.

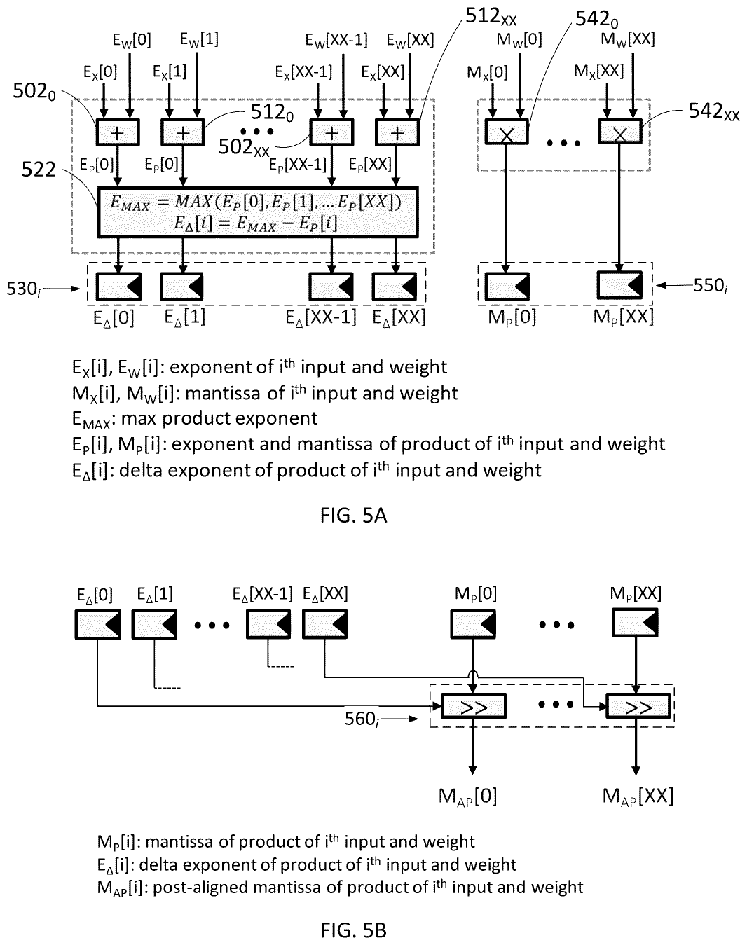

A portion 400 of the system 300, in some embodiments, is depicted in more detail in FIG. 4. The multiplier for multiplying an XX+1 mantissas M_{X} of input signals and XX+1 mantissas M_{W} of weight values includes XX+1 multipliers 412ᵢ (i=0, 1, 2, . . . , XX). Each multiplier 412ᵢ is configured to receive a respective M_{Xi} of M_{X} and respective M_{Wi} of M_{W}, and generate a product of the M_{Xi} and M_{Wi} and output the product mantissa M_{P} to storage 430ᵢ. The product mantissa alignment portion 314a of the alignment and rounding circuit 314 include XX+1 shifters 414ᵢ, each of which receives a respective product mantissa M_{P}[i] and ΔE[i] (or E_{Δ}[i]) and shifts the M_{P}[i] by E_{Δ}[i] bits to generate a respective post-alignment product mantissa M_{AP}[i] 444ᵢ.

The rounding portion 314b of the alignment and rounding circuit 314 include XX+1 adders 416ᵢ, which rounds the M-bits truncated mantissa, M_{AP}[i][0:M−1], consisting of the most significant M-bits, by adding the value of the M-th bit, M_{AP}[i][M], to the M-bits truncated mantissa. The resultant M-bit rounded truncated product mantissa 428ᵢ is output to respective storage 430ᵢ and subsequently output to the summing device, such as an adder tree 318.

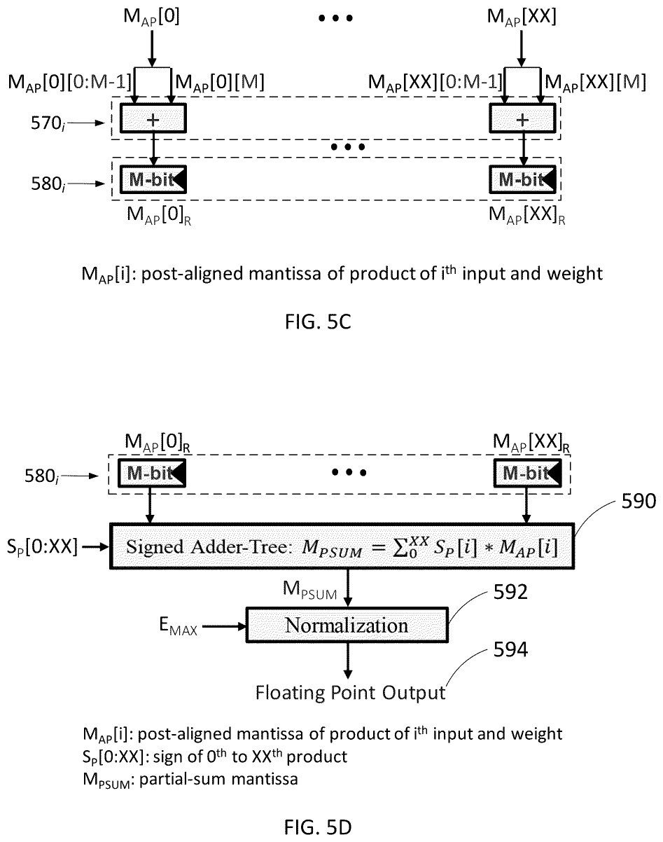

FIGS. 5A-5D illustrate a step-by-step MAC operation according to some embodiments. To multiply a set of input numbers and a set of weight values, the exponents E_{X}[i] of the input numbers are added 502ᵢ to respective exponents E_{W}[i] of the weight values to obtain the product exponents E_{P}[i]. In the next step 522, the maximum product exponent E_{MAX} among all product exponents is then identified, and the difference, E_{Δ}[i], between the exponent of each product mantissa and the maximum exponent is calculated and stored in memory locations 530ᵢ.

Further, the mantissas M_{X}[i] of the input numbers are multiplied 542ᵢ by respective mantissas M_{X}[i] of the weight values, and the product mantissas M_{P}[i] are stored in memory locations 550ᵢ. See FIG. 5A.

The product mantissas M_{P}[i] are then aligned with each other using E_{Δ}[i]. In some embodiments, such as the example shown in FIG. 5B, the product mantissas are multiplied by the base raised to respective E_{Δ}[i]-th power, so that the product mantissas have the same, maximum exponent after the modifications. The multiplication of the mantissa by the base raised to the E_{Δ}[i]-th power in this example is implemented by shifting, using shifters 560ᵢ, the product mantissa to the right by E_{Δ}[i] bits to produce point-alignment product mantissas M_{AP}[i]. That is, the mantissa is divided by 2^{EΔ[i]}, and the exponent is effectively increased by E_{Δ}[i] and become the maximum exponent. The product mantissas are then post-alignment product mantissas.

Next, as shown in FIG. 5C, the M-bit truncated mantissa, M_{AP}[i][0:M−1], consisting of the most significant M-bits, and the value of the M-th bit, M_{AP}[i][M], of each post-alignment product mantissa M_{AP}[i] are output to adders 570ᵢ to be added 590 to each other. The resultant rounded M-bit truncated mantissas M_{AP}[i]_{R} are stored in memory locations, such as registers 580ᵢ.

Next, as shown in FIG. 5D, the rounded M-bit truncated mantissas M_{AP}[i]_{R} are added together as an algebraic sum, i.e., a sum of M_{AP}[i]_{R}, each with the sign S_{P}[i] of the respective product mantissa, to generate a partial-sum mantissa M_{PSUM}. Finally, the partial-sum mantissa M_{PSUM} and E_{MAX} are then combined and normalized, as described above to generate a floating point partial sum 594.

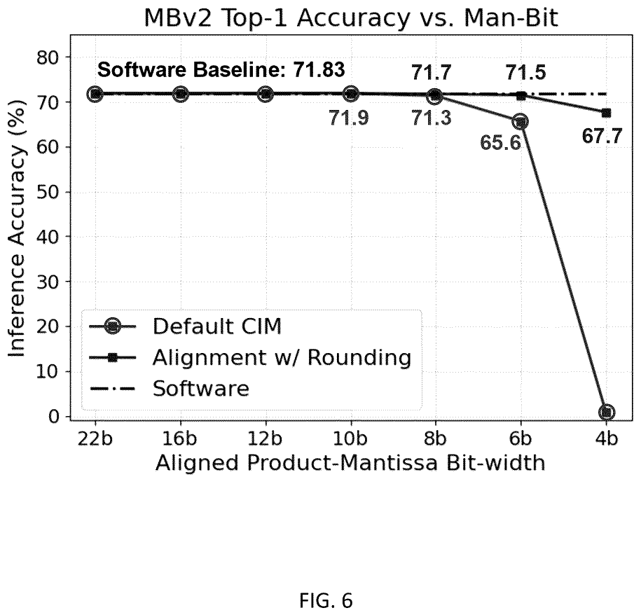

The product mantissa truncation with rounding, with proper choice of the truncated bit-width, M, can substantially reduce computational errors due to shortened bit-widths, thereby preserve inference accuracy in machine learning. As an example, as shown in FIG. 6, as bit-width of post-alignment product mantissas is reduced, the inference accuracy for simple truncation without rounding deteriorates, whereas the inference accuracy for truncation with rounding decreases significantly less. In some embodiments, appropriate choice for the truncated bit-width, M, for truncation with rounding can be ascertained by benchmarking.

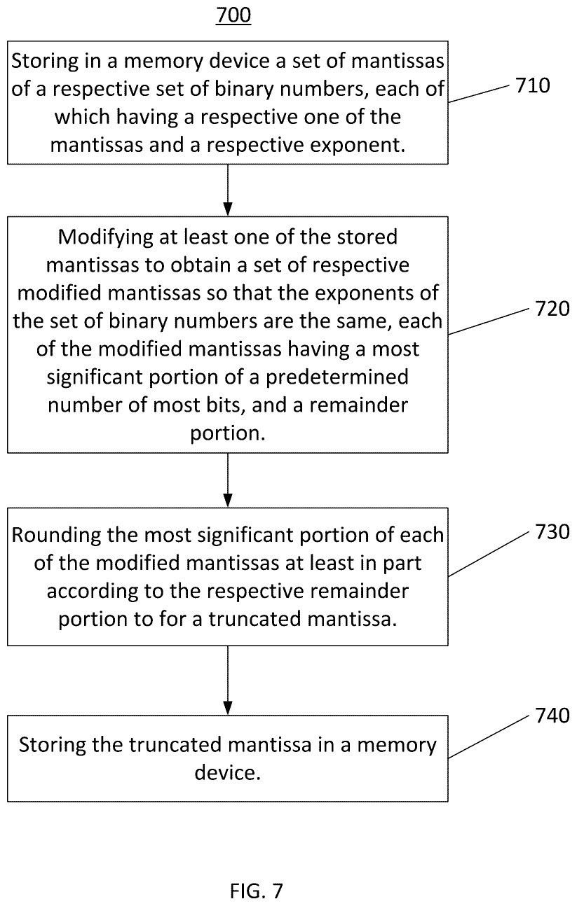

In more general terms, a computing process according to certain aspects of the present disclosure, as outlined in FIG. 7, includes: storing 710 in a memory device a set of mantissas of a respective set of binary numbers, each of which having a respective one of the mantissas and a respective exponent; modifying 720 at least one of the stored mantissas to obtain a set of respective modified mantissas so that the exponents of the set of binary numbers are the same, each of the modified mantissas having a most significant portion of a predetermined number of most bits, and a remainder portion; rounding 730 the most significant portion of each of the modified mantissas at least in part according to the respective remainder portion to for a truncated mantissa; and storing 740 the truncated mantissa in a memory device.

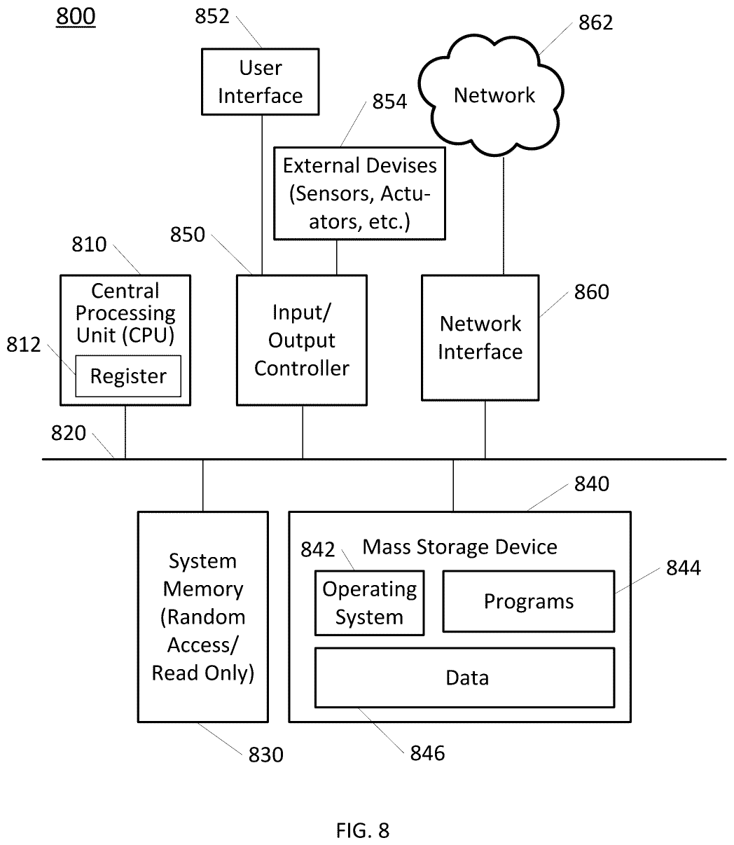

As stated earlier, the computing method described above can be implemented by any suitable system. For example, as an alternative to performing the mantissa multiplications in CIM memory, a processor-based operation can be used, for example, in a computer programed to perform algorithms outlined above. For example, a computer system 800 shown in FIG. 8 can be used. In this example, the computer 800 includes a processor 810, which can include register 812 and is connected to the other components of the computer via a data communication path such as a bus 820. The components include system memory 830, which is loaded with the instructions for the processor 810 to perform the methods described above. Included is also a mass storage device, which includes a computer-readable storage medium 840. The mass storage device is an electronic, magnetic, optical, electromagnetic, infrared, and/or a semiconductor system (or apparatus or device). For example, the computer-readable storage medium 840 includes a semiconductor or solid-state memory, a magnetic tape, a removable computer diskette, a random access memory (RAM), a read-only memory (ROM), a rigid magnetic disk, and/or an optical disk. In one or more embodiments using optical disks, the computer-readable storage medium 840 includes a compact disk-read only memory (CD-ROM), a compact disk-read/write (CD-R/W), and/or a digital video disc (DVD). The mass storage device 840 stores, among other things, the operating system 842; programs 844, including those that, when read into the system memory 820 and executed by the processor 810, cause the computer 800 to carry out the processes described above; and Data 846. The computer 800 also includes an I/O controller 850, which inputs and outputs to a User Interface 852. The User Interface 852 can include, for example, various parts of the vehicle instrument cluster, audio devices, a video display, input devices such as buttons, dials, a touch-screen input, a keyboard, mouse, trackball and any other suitable user interfacing devices. The I/O controller 850 can have further input/out ports for input from, and/or output to, devices such as External Devices 854, which can include sensors, actuators, external storage devices, and so on. The computer 800 can further include a network interface 860 to enable the computer to receive and transmit data from and to remote networks 862, such as cellular or satellite data networks, which can be used for such tasks as remote monitoring and control of the vehicle and software/firmware updates.

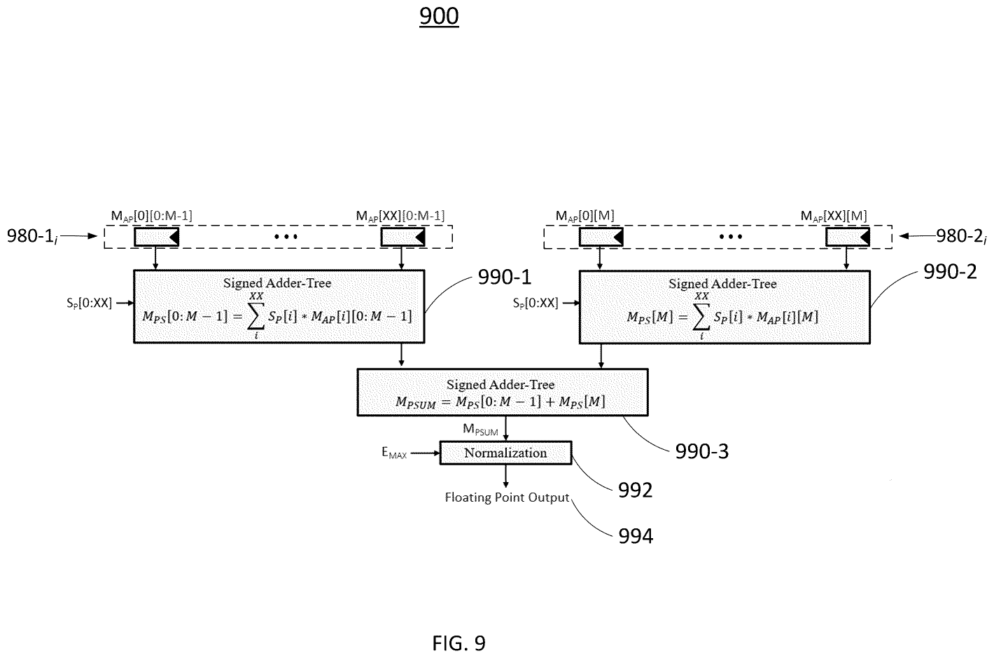

In certain further embodiments, as illustrated in FIG. 9, instead of rounding each truncated product mantissa, as shown in FIGS. 1A and 2-5D, the same effect of rounding can be achieved by separately obtaining 990-1 the algebraic sum of truncated product mantissa M_{AP}[i][0:M−1] without rounding and obtaining 990-2 the algebraic sum of the M-th bits M_{AP}[i][M] of the product mantissas, and obtaining 990-3 the algebraic sum of the two algebraic sums to obtain the partial sum product mantissa M_{PSUM}.

Thus, in accordance with some disclosed embodiments, a method of computing includes, for a plurality of binary numbers, each having a respective mantissa, sign associated with the mantissa, and exponent, providing in a memory device the mantissas. At least one of the mantissas provided in the memory device is modified to obtain a plurality of respective modified mantissas so that the exponents of the plurality of binary numbers are the same. Each of the modified mantissas has a most significant portion of a predetermined number of most significant bits, and a remainder portion. The modified mantissas are stored in a memory device. The most significant portion of each of the stored modified mantissas are rounded at least in part according to the respective remainder portion to generate a truncated mantissa. The truncated mantissas are stored in a memory device without storing the remainder portions.

In accordance with further embodiments, a method of computing includes, for a plurality of binary numbers, each having a respective mantissa, sign associated with the mantissa, and exponent, providing in a memory device the mantissas. At least one of the mantissas provided in the memory device is modified to obtain a plurality of respective modified mantissas so that the exponents of the plurality of binary numbers are the same. Each of the modified mantissas has a most significant portion of a predetermined number of most bits, and a remainder portion having a most significant bit. The most significant portions of the plurality of modified mantissas are combined. The combination of the most significant portions of the plurality of modified mantissas are modified at least in part according to at least one of the remainder portions to generate a truncated mantissa. The modified combination is stored in a memory device.

In accordance with still further embodiments, a computing device includes one or more first digital circuits configured to receive a plurality of digital input signals indicative of respective input digital numbers of a base. Each of the one or more first digital circuits is configured to receive a respective one or more of the digital input signals and modify each of the one or more of the digital input signals to generate a respective output signal indicative of an output digital number that is the input digital number times an integer power of the base. One or more second digital circuits are configured to round a most significant portion of a predetermined bits of each output digital number from the one or more first digital circuits depending at least in part on a remainder portion of the output digital number to generate an output signal indicative of the rounded most significant portion without the respective remainder portion. An accumulator is configured to combine the output signals of the one or more second digital circuits.

This disclosure outlines various embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method of computing, comprising:
for a plurality of binary numbers, each having a respective mantissa, sign associated with the mantissa, and exponent, providing in a memory device the mantissas;
modifying at least one of the mantissas provided in the memory device to obtain a plurality of respective modified mantissas so that the exponents of the plurality of binary numbers are the same, each of the modified mantissas having a most significant portion of a predetermined number of most significant bits, and a remainder portion, and storing the modified mantissas in a memory device;
rounding the most significant portion of each of the stored modified mantissas at least in part according to the respective remainder portion to generate a truncated mantissa; and
storing the truncated mantissas in a memory device without storing the remainder portions.

2. The method of claim 1, wherein the rounding comprises rounding the most significant portion of each of the stored modified mantissas at least in part based on a most significant bit of the respective remainder portion.

3. The method of claim 2, wherein the rounding comprises generating a sum of the most significant portion of each of the stored modified mantissas and the most significant bit of the respective remainder portion.

4. The method of claim 1, wherein the providing in a memory device a plurality of mantissas comprises multiplying, using a multiply circuit, each of a first set of factors by at least one of a second set of factors to generate a respective one of the mantissas.

5. The method of claim 4, wherein the multiply circuit comprises:
a memory array; and
a logic circuit coupled to the memory array,
wherein the multiplying comprises storing the second set of factors in the memory array and applying signals, each indicative of a respective one of the first set of factors, to the logic circuit to generate output signals, each of which based on a respective one of the signals indicative of the first set of signals and at least one of the stored second set of factors.

6. The method of claim 1, wherein the modifying at least one of the stored mantissas comprises shifting the at least one of the stored mantissas by a number of bits at least in part according to a difference between the exponent of the at least one of the stored mantissas and the exponent of another one of the stored mantissas.

7. The method of claim 1, further comprising combining the truncated mantissas to generate a partial-sum mantissa.

8. The method of claim 6, wherein the combining the truncated mantissas comprise generating an algebraic sum of the truncated mantissas with the associated signs.

9. A method of computing, comprising:
for a plurality of binary numbers, each having a respective mantissa, sign associated with the mantissa, and exponent, providing in a memory device the mantissas;
modifying at least one of the mantissas provided in the memory device to obtain a plurality of respective modified mantissas so that the exponents of the plurality of binary numbers are the same, each of the modified mantissas having a most significant portion of a predetermined number of most bits, and a remainder portion having a most significant bit;
combining of the most significant portions of the plurality of modified mantissas;
modifying the combination of the most significant portions of the plurality of modified mantissas at least in part according to at least one of the remainder portions to generate a truncated mantissa; and
storing the modified combination in a memory device.

10. The method of claim 8, wherein the modifying the combination of the truncated portions of the plurality of modified mantissas comprises:
generating an algebraic sum of the most significant portions with the associated signs;
generating an algebraic sum of the most significant bits of the remainder portions with the associated signs; and
adding the algebraic sum of the most significant bits of the remainder portions to the sum of the most significant portions.

11. The method of claim 8, wherein:
the modifying the combination of the truncated portions of the plurality of modified mantissas comprises rounding the most significant portion of each of the modified mantissas at least in part according to the respective remainder portion to generate a truncated mantissa; and
the combining of the most significant portions of the plurality of modified mantissas comprises combining the truncated mantissas.

12. The method of claim 10, wherein the rounding comprises rounding the most significant portion of each of the stored modified mantissas at least in part based on a most significant bit of the respective remainder portion.

13. The method of claim 11, wherein the rounding comprises generating a sum of the most significant portion of each of the stored modified mantissas and the most significant bit of the respective remainder portion.

14. The method of claim 1, wherein the providing in a memory device a plurality of mantissas comprises storing a first set of factors in a memory array and multiplying, using a multiply circuit, each of a second set of factors by a respective one of the first set of factors to generate a respective one of the mantissas.

15. The method of claim 8, wherein the modifying at least one of the stored mantissas comprises shifting the at least one of the stored mantissas by a number of bits at least in part according to a difference between the exponent of the at least one of the stored mantissas and the exponent of another one of the stored mantissas.

16. A computing device, comprising:
one or more first digital circuits, configured to receive a plurality of digital input signals indicative of respective input digital numbers of a base, each of the one or more first digital circuits being configured to receive a respective one or more of the digital input signals and modify each of the one or more of the digital input signals to generate a respective output signal indicative of an output digital number that is the input digital number times an integer power of the base;
one or more second digital circuits configured to round a most significant portion of a predetermined bits of each output digital number from the one or more first digital circuits depending at least in part on a remainder portion of the output digital number to generate an output signal indicative of the rounded most significant portion without the respective remainder portion; and
an accumulator configured to combine the output signals of the one or more second digital circuits.

17. The computing device of claim 16, wherein each of the first one or more second logic circuits each comprise an adder configured to receive from the one or more first digital circuit the most significant portion of a respective output digital number and the most significant bit of the remainder portion of the respective output digital number and generate an output indicative of a sum of the received most significant portion of the received output digital number and the most significant bit of the remainder portion of the received output digital number.

18. The computing device of claim 17, wherein the one or more first digital circuits each comprise a register circuit configured to store one of the input digital numbers, receive a shift signal indicative of an integer, and shift the input digital number by a number of bits corresponding to the shift signal.

19. The computing device of claim 18, further comprising a multiply circuit configured to multiply each of a first set of factors by at least one of a second set of factors to generate a respective one of the input digital numbers.

20. The computing device of claim 18, further comprising a digital circuit configured to select a maximum integer from a plurality of integers and output a difference between each of the plurality of integers and the maximum integer, wherein each integer indicated by the respective shift signal corresponds to the difference between each of the plurality of integers and the maximum integer.
